(19) United States
(12) Patent Application Publication
(10) Pub. No.: US 2009/0125164 A1
(43) Pub. Date: May 14, 2009

(54) Integrated electronic module for visualizing digital instruments on a display

(76) Inventor: Ferdinando Perrotta, Ardea (IT)

Correspondence Address: YOUNG & THOMPSON, 209 Madison Street, Suite 500, ALEXANDRIA, VA, 22314, US

(21) Appl. No.: 11/666,232

(22) PCT Filed: Oct. 28, 2005
(86) PCT No.: PCT/IT05/00637

§ 371 Date: Apr. 25, 2007

(30) Foreign Application Priority Data
Oct. 29, 2004 (IT) RM2004A000535

(51) Int. Cl. G01C 23/00

(52) U.S. Cl. 701/3

(57) ABSTRACT

An electronic control unit includes in combination: a data collection element form sensors and instruments existing on board of the transport device, a collected-data processing element, a data storage element, a graphic display element, a radio communication element, and an input/output pilot interface element. The storage element includes a removable or fixed memory card.

On board of passenger airliners as well as special nautical means and land vehicles the instruments consist in combination of a number of separate indicators, each of them being connected to its own sensing means.

As a result the pilot has to look out continuously to all information supplied by the instruments so that he can check the current situation and, if necessary, carry out adjustments or controls.

It is then evident that if the operations mentioned above are rather easy under normal operating conditions, they can become extremely difficult in case of failure and/or under bad weather conditions and/or short visibility.

In fact, an expert pilot (for example, a pilot of military aircrafts or airliners) is capable of coping with the situation even under such adverse conditions as first of all he is well trained to keep his temper and secondly to behave properly in the face of any circumstances.

The situation is quite different in light or ultra-light aviation and/or air touring where pilots are less expert as they are used to fly mainly under rather perfect visibility and good weather conditions.

In such cases, any emergency situation can give rise to panic that prevents the pilot from or limits him in his capability of reading and/or processing data supplied by the instruments, thus causing frequent serious accidents that could be avoided if the pilot kept his temper or acted properly as a result of data shown by the instruments.

The main object of the present invention is to overcome such problems by providing an apparatus able to process and supplement data of the instruments that gives the pilot an immediately understandable graphical indication of the conditions of the transport, vehicle, its position and ground speed and other geographical references.

A second object of the invention is to provide an apparatus able to store in addition to typical data of the so-called “black box” also data of the whole way so that all steps of the way can be shown on a display together with data supplied by the instruments.

A third object of the invention is to provide an apparatus able to store data supplied by the instruments on a removable support which can be read by a PC provided with a suitable software to read data stored therein and to process them according to requirements.

This has been accomplished according to the present invention by providing an electronic control unit including in combination: data collection means from sensors and instruments of the transport means, collected-data processing means, data storage means, diagram display means, radio communication means, and input/output pilot interface means.

A better understanding of the invention will result from the following description with reference to the accompanying drawings that show only by way of a not limiting example a preferred embodiment developed for aeronautical applications, however, it is self-evident that the same purposes and advantages occur in land and naval applications.

In the drawings:

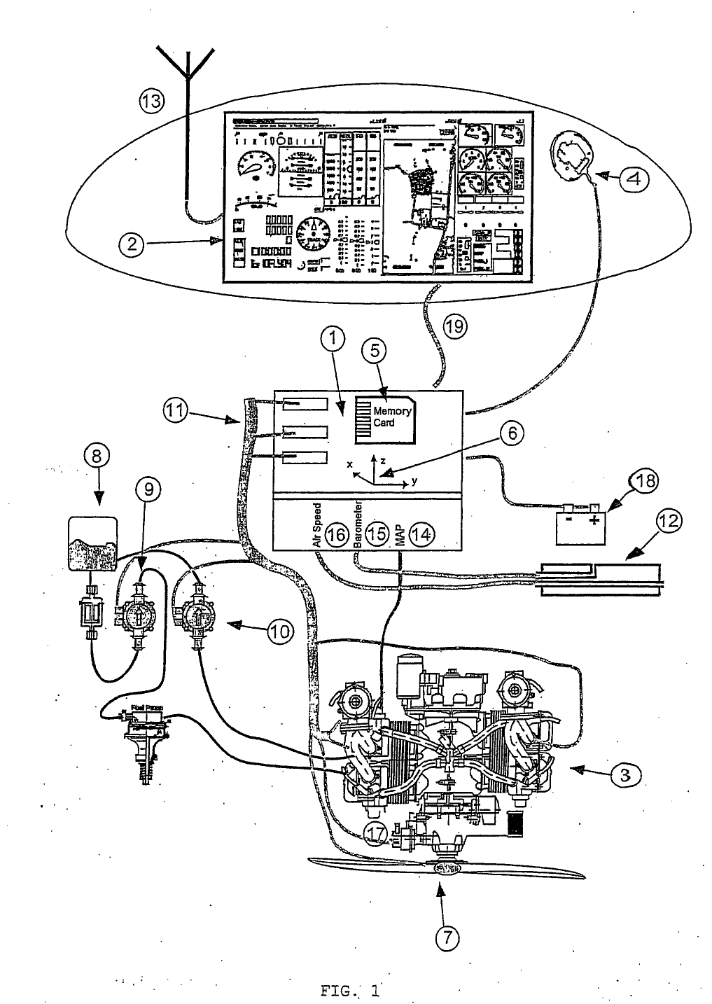

FIG. 1 is a schematic view of the main parts of the invention applied to an aircraft with internal-combustion engine;

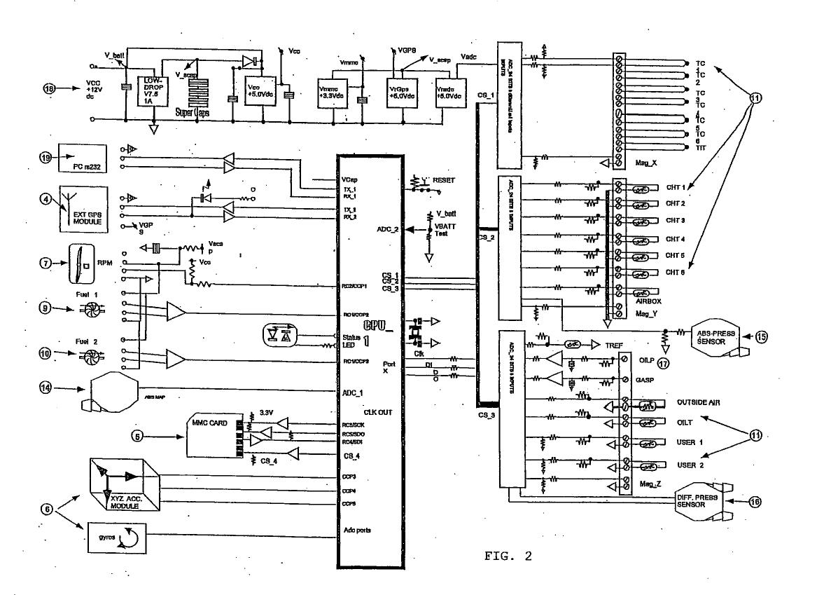

FIG. 2 is a circuit diagram of the electronic control unit according to the invention;

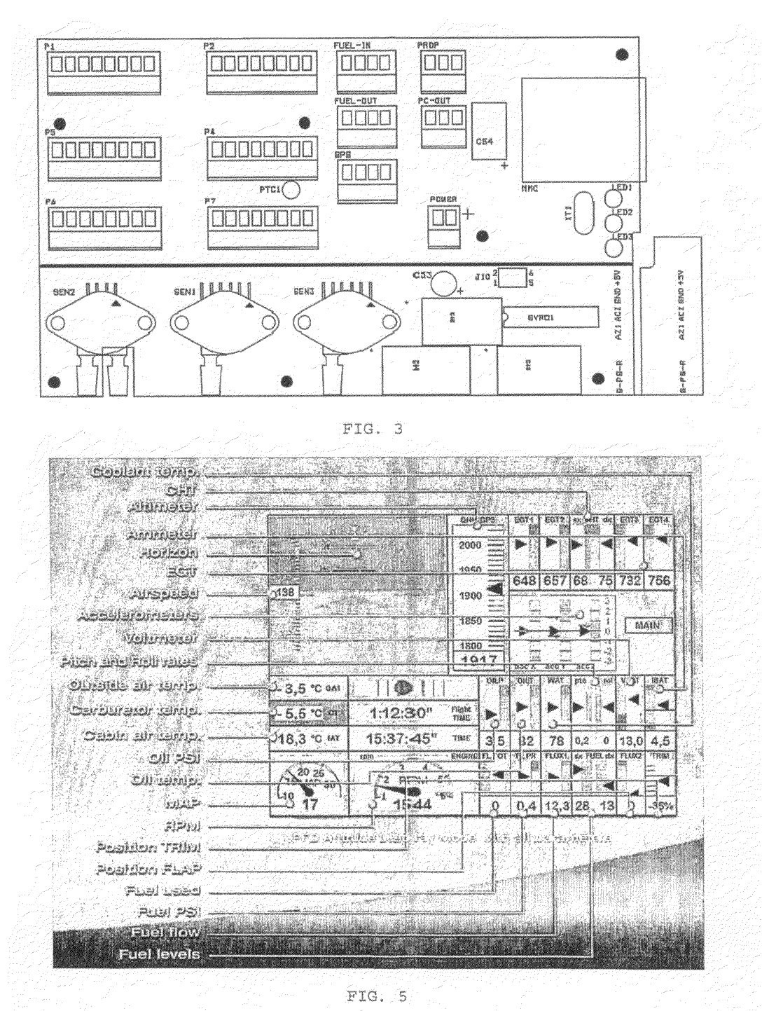

FIG. 3 shows schematically an example of the layout of the connections between control unit and sensors, PC, and outside devices;

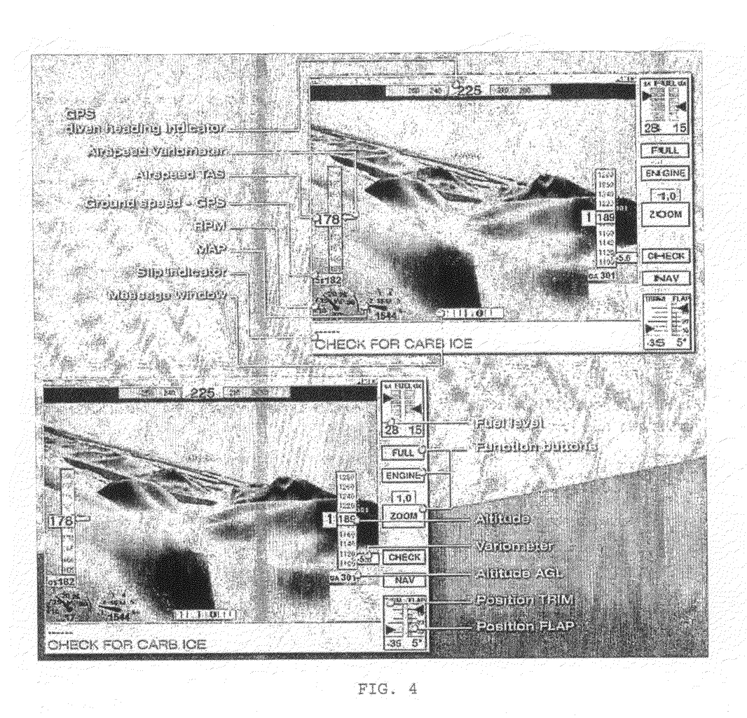

FIG. 4 shows an example of a graphic three-dimensional view produced by the present invention in real time or by data stored in the control unit; and

FIG. 5 shows all main instruments and flight data.

In the preferred embodiment disclosed the invention simplifies the connections between measuring units and sensors by connecting them to an electronic control unit 1 where the signals are converted from analogue to digital form, assembled into information packets and sent through serial interface 19 to outside display unit 2 that can consist of:
a display with industrial computer;
a pocket PC (PDA);
a Personal Computer (PC);
a Tablet PC with solid state memory.

According to the invention, the technical solution disclosed that provides an important development and a simplification of the existing solutions includes in combination:

a) automatic storage means for storing all collected data to an electronic support (5) embodied in a control unit (1);
b) automatic communication means for the connection to a rescue centre in case of accident by a communication unit connected to PC, (2): the system uses data from accelerometer (6) to determine the seriousness of the accident (acceleration up to 2 g means light damages, up to 4 g serious damages, above 4 g very serious damages); additionally, by GPS connection (4), the system is able to calculate the coordinates of the site of accident with enough precision. The finding is thus able to forward automatically a call to the rescue centre;
c) data collected by the control unit and sent to the display means allows a digital display of the board instruments including: artificial horizon, altimeter, and speedometer.

### Artificial Horizon.

This instrument is the trim indicator that allows pitch and roll of the aircraft or the vehicle or the vessel to be shown simultaneously.

As far as the trim is concerned, further information can be provided, for example in case of accident, by using gyroscopes in addition to accelerometers 6. In case of head-on or side collision, the information provided by accelerometers 6 can be sufficient to reconstruct the sequence of the accident. In case the transport means capsizes, such information is not enough, while the gyroscopes provides all additional information which is necessary to reconstruct the accident. This instrument allows the position, of the aircraft with respect to the real horizon to be kept under control even without outside visibility.

### Altimeter.

This instrument is used to measure the vertical distance, of an object (aircraft) relative to a fixed altitude (for example the sea, level or MSL). The most sophisticated aircrafts have two different types of altimeters: pressure altimeter 15 and radar altimeter. The first one measures the variation of the static pressure outside the aircraft and transform it into a measure of the altitude relative to a reference value which can be selected in the instrument by a suitable knob. The measure of the altitude is usually indicated by an index (in hundreds and thousands feet). The drawback of such system is to set every time the reference pressure. The radar altimeter measures the vertical distance of an object (aircraft) from the ground by radio waves; it is used on board of commercial aircraft only for altitudes between 0 and 2500 feet, thus ensuring an excellent precision. GPS altimeter 4 offers the same precision as a radar altimeter but without limiting the altitude.

The control unit object of the present invention includes a sensor which allows the conversion to the altitude of pressure altimeter 15 according to the definition of “ICAO standard atmosphere”. The altitude is also measured by a properly arranged GPS instrument 4.

The air speed at which an aircraft moves can be measured and calculated in different ways:

IAS (Indicated Air Speed) is the speed indicated by anemometer 16 and is expressed in knots. Anemometer is an instrument that allows the aircraft air speed to be measured and displayed. The instrument includes a Pitot tube 12 measuring the difference between the total pressure and the static pressure of air and calculating the dynamic pressure that can be converted into speed usually indicated in knots by counters or gauges.

CAS (Calibrated Air Speed) is obtained from the speed indicated by correcting both the instrument error and the position error.

TAS (True Air Speed) is obtained from, the speed indicated by effecting the adjustments due to the air density according to temperature and pressure.

GS (ground speed) is the speed relative to ground obtained from TAS by effecting the adjustments due to headwind or tailwind or supplied by GPS 4. In this case the measurement sets aside the barometric measurements and the relative adjustments.

Wind indicator is an instrument that calculates the direction of wind. The control unit disclosed includes a differential pressure sensor 16 producing a signal by digital conversion that can be processed to provide both IAS, CAS and TAS. Additionally, GPS 4 can also provide GS. Wind intensity, and direction can be obtained from the combination of such data.

Turn-and-bank indicator is an instrument able to indicate simultaneously the turn angle and if the working has been coordinated or not. Generally this indicator consists of two instruments: a gyroscope indicating whether the aircraft is turning right or left, and a “ball” indicating if the turn is coordinated with the correct bank. Only if the ball is at the centre, the aircraft is turning correctly as the force of gravity, combined with the centrifugal force due to the turn keeps the ball at the centre. This means that the force resulting from the sum of force of gravity and centrifugal force is a force directed along the local vertical of the aircraft.

According to the finding, control unit 1 reconstructs turn/bank indicator from data of GPS 4 and accelerometers 6 as well.

Variometer is an instrument measuring the vertical component of the speed by the variation of barometric pressure 15. By this instrument the pilot is able to know whether the aircraft is climbing or losing height with respect to its trim.

Compass: when the position in terms of latitude and longitude is known in two following moments, the GPS can calculate the direction of movement expressed as “TRACK”. Once the direction of movement without side wind is known, the direction which the aircraft's nose points to can coincide with the direction of movement that also corresponds to the direction indicated by the magnetic compass.

Moving Map: a PC 2 connected to control unit 1 is able to produce a moving map to be used in real time as the control unit provides all parameters necessary to this end. The effect is similar to a flight simulator with the difference that data displayed are real data and corresponds to the actual flight.

The system disclosed can be used for a number of purposes:

Black box: data storage unit stores at regular intervals all information relative to engine 3: engine revolutions 7, temperature 11, oil pressure 17, battery voltage 18, attitude and position 6 of the aircraft-vessel-vehicle. The finding is actually a black box that allows, in case of emergency, the dynamics, the causes and the responsibilities of any accident to be known.

Autopilot: the PC connected to control unit 1 receives all information necessary to implement an autopilot.

The PC receives the parameters relative to engine and the trim and is capable of interacting with the board device and controls by suitable mechanical, pneumatic, electronic equipments. Thus, a system can be implemented that allows some parameters to be adjusted such as altitude and/or course to be held (calculated in a semiautomatic manner to avoid air districts forbidden to the air traffic or even air districts in which the short-range weather forecast foresees weather not favourable to navigation, etc.), cruising speed, ad all other parameters necessary to complete long distances or distances in which the intervention of the pilot is not necessary.

According to a peculiar feature of the invention, all collected data by control unit 1 are also stored on a removable memory support such as a “memory card” of the known type which can be removed at the end of the flight to see again and analyse all steps from take-off to landing, for example for teaching purposes. To this end control unit 1 hitherto disclosed is provided with a suitable memory card reading/writing unit.

With reference to the foregoing it is evident that control unit 1 hitherto disclosed is provided with interface means with sensors and typical instruments existing on, board of aircrafts-vessels-vehicles, collected-data processing means, data storage means, output pilot interface means for displaying and sound signalling, input pilot interface means to set the required functions and the operating parameters, radio transceiver means, global positioning system (GPS) means.

In the disclosed embodiment shown in FIG. 1 with reference to a propeller airplane with internal-combustion engine, the finding includes: electronic control unit 1, display 2 (PDA-PC, tablet PC), GPS instrument 4, (fixed and/or removable) data storage card 5, trim sensors 6 (accelerometers and gyroscopes), revolution sensor 7 of propulsor or engine 3, delivery sensor 9 and backflow sensor 10 of the fuel of tank 8, sensors 11 (thermocouples, NTC, RTC) of the temperature of fuel, oil and for general purposes, at least a Pitot tube 12 (static and dynamic intake), Rx/Tx antenna 13 (GSM, GPRS, UMTS, pressure sensor 14 of air-fuel mixture in the cylinder, barometric sensor 15, air speed sensor 16, oil pressure sensor 17, battery 18, serial connection 19 to display 2.

According to a further peculiar feature of the finding, such control unit is able to, be connected to a PC provided with a software able to generate a three-dimensional graphic sight showing the landscape that the pilot would see in real time looking out of the cabin under optimum visibility conditions (FIG. 4).

Such three-dimensional graphic display of the ground flown over can be coupled with the main parameters relative to airplane and flight, such as speed, altitude, fuel, engine revolutions, attitude, flap position and trim.

As an alternative, the above-mentioned graphic display can be replaced by a display of all main instruments and the flight parameters (FIG. 5) with the advantage that if one or more quantities has an out-of-standard value, they are immediately displayed to the pilot (for example by a change of colour and/or by flashing).

The control unit provides data to PC that displays it in real time or allows data already stored on memory card to be read by data entry into serial interface according to NMEA standard. This format defines proprietary strings by which additional data can be sent unlike a typical GPS. Therefore, a correct output data display (at least data collected from GPS) can be carried out on any PC having a suitable program for reading and displaying NMEA data available on the market and usually sold for glider flight examination. According to the invention, a control unit is provided that controls continuously the supply voltage and uses the energy reserve accumulated in special capacitors with the function of buffer battery in order to guarantee the correct operation of the control unit disclosed above also under the most difficult operating conditions and to ensure automatically the storage on memory card of the last collected data even if battery supply fails suddenly. The same supplying circuit guarantees the operation continuity of GPS receiver, a further function of the buffer battery, even if the battery voltage decreases at the engine ignition.

To this end, it should be appreciated that, as the starter is driven, the power supply decreases from the rate of 12 V to less than 7 V. The correct data registration relative to the starting step is important as it can support by documentary evidence the ignition problems at low temperature which cannot be re-established by the fitter.

In a preferred embodiment of the finding components of the last generation are used on a multilayered printed board and particular attention is paid to the electromagnetic compatibility so that the control unit does not produce or is influenced by electric and/or electromagnetic noise.

The connection of the control unit to the display is established preferably by a single cable which transfers data relative to engine, GPS, flight or the distance covered. All detected data (including GPS) is registered on the memory card from which it can be read on a PC through a high-speed USB gate by transferring, for example, one hour of flight in less than 50 seconds.

It is also possible to seal the memory card so that the change of its content may only, be carried out by removing it from its housing, thus breaking the seal.

1. An electronic control unit (1), characterized in that there are provided in combination: data collection means from sensors and instruments existing on board of the transport means, collected-data processing means, data storage means, graphic display means, radio communication means, and input/output pilot interface means; said control unit being able to be connected to a processor or PC provided with a suitable software which is able to produce a three-dimensional graphic display showing in real time and apart from the actual atmospheric conditions and/or outside visibility the landscape that the pilot would see looking out of the cabin under optimum visibility conditions.

2. The control unit (1) according to claim 1, characterized in that said storage means includes a removable or fixed memory card (5).

3. The control unit (1) according to claim 1, characterized in that said graphic display means (2) is able to show integrated instruments including artificial horizon and/or altimeter and/or turn, roll and pitch indicators and/or variometer and/or anemometer and/or gravity indicator.

4. The control unit (1) according to claim 1, characterized in that it includes a sensor of the position of the gas throttle (14), a sensor (9) of the input fuel flow, a sensor (10) of the output fuel flow, and a fuel level sensor (8).

5. The control unit (1) according to claim 1, characterized in that it includes trim sensors (6) of the transport means, sensors detecting the position of the control means and drive means (autopilot).

6. The control unit (1) according to claim 1, characterized in that the data collection means processes data and send it to said processing means consisting of an outside processor which is able to use it to implement a moving map or an artificial sight system by a signal from a transceiving antenna (13) via GSM, GPSR, UMTS.

7. The control unit (1) according to claim 1, characterized in that it is connected to: a display (2) provided with data processing means (PDA-PC, tablet PC); GPS instrument (4); fixed and/or removable data storage card (5); trim sensor (6); engine (3) revolution sensor (7); delivery sensor (9) and backflow sensor (10) for the fuel of tank (8); temperature sensors (11) able to detect the temperature of fuel, oil, and fox general purposes; at least a Pitot tube (12); transceiving radio antenna (13); pressure sensor (14) of air-fuel mixture of the engine; barometric sensor (15); air speed sensor (16); oil pressure sensor (17); battery (18), serial connection (19) to display (2).

8. The control unit (1) according to claim 1, characterized in that in case the transport means is an aircraft, said three-dimensional graphic display shows the ground flown over and can be coupled with a synthetic sight of the main parameters relative to airplane and flight, such as speed, altitude, fuel, engine revolutions, attitude, flap position and trim.

9. The control unit (1) according to claim 5, characterized in that in case the transport means is an aircraft, said three-dimensional graphic display is replaced by a display of all main instruments and the flight and aircraft parameters so that if one or more quantities shown has an out-of-standard value, they are immediately displayed to the pilot (for example by a change of colour and/or by flashing).

10. An electronic control unit (1) as essentially disclosed and, illustrated in the present description and the accompanying drawings.
